(19) United States
(12) Patent Application Publication
(10) Pub. No.: US 2014/0162231 A1
(43) Pub. Date: Jun. 12, 2014

(54) METHOD FOR DEVELOPING PERCEPTUAL MOTOR SKILLS

(71) Applicant: ACCO Brands Corporation, Lake Zurich, IL (US)

(72) Inventor: Toni Schulken, Charlotte, NC (US)

(73) Assignee: ACCO Brands Corporation, Lake Zurich, IL (US)

(21) Appl. No.: 14/183,027

(22) Filed: Feb. 18, 2014

Related U.S. Application Data
(62) Division of application No. 13/059,342, filed on Feb. 16, 2011.
(60) Provisional application No. 61/094,373, filed on Sep. 4, 2008.

(51) Int. Cl. G09B 19/00

(52) U.S. Cl. CPC G09B 19/00
USPC 434/261; 434/258

(57) ABSTRACT

A method for developing a user's perceptual motor skills. The method includes providing a plurality of sheets and providing, on each of the plurality of sheets, a skill development activity to be completed by a user. Collectively, the skill development activities require the user to employ each of the user's visual discrimination skills, visual memory skills, visual spatial relationship skills, visual form constancy skills, visual sequential memory skills, visual figure ground skills, and visual closure skills. The method includes providing pictorial indicia on each of the plurality of sheets that provides a thematic link between the plurality of sheets, binding the plurality of sheets together in a predetermined order, and cuing the user to complete the skill development activities of the plurality of sheets in the predetermined order.

### REFERENCE TO RELATED APPLICATIONS

This application is a divisional of application Ser. No. 13/059,342 filed on Feb. 16, 2011, which was a U.S. national stage filing of PCT/US2009/055475 filed on Aug. 31, 2009, which in turn claimed the benefit of priority under 35 U.S.C. §119(e) of U.S. provisional application Ser. No. 61/094,373 filed on Sep. 4, 2008. Each of these applications is hereby incorporated by reference in its entirety.

The present invention is directed to a method for developing perceptual motor skills, and more particularly, to a method for developing perceptual motor skills through a variety of activities.

### BACKGROUND

As children and other users begin to learn the basic skills needed for reading, writing, mathematics, organization and other skills, they need to learn a variety of visual perception skills and perceptual motor skills.

### SUMMARY

The present invention provides a method in which many or all of the seven visual perceptual skills identified in the widely used and norm-based assessment of the Test of Visual Perceptual Skills 3 (TVPS 3) are developed. These skills include visual spatial relationships, visual discrimination, visual memory, sequencing (visual sequential memory), visual closure, visual memory, form constancy and visual figure ground in a fun and challenging manner. The present invention may also help to develop visual motor skills and ocular motor skills. All of these skills may be taught to a user in an entertaining yet challenging manner.

### BRIEF DESCRIPTION OF FIGURES

FIGS. 1-10 show a variety of sheets or pages of a perceptual motor development system.

### DETAILED DESCRIPTION

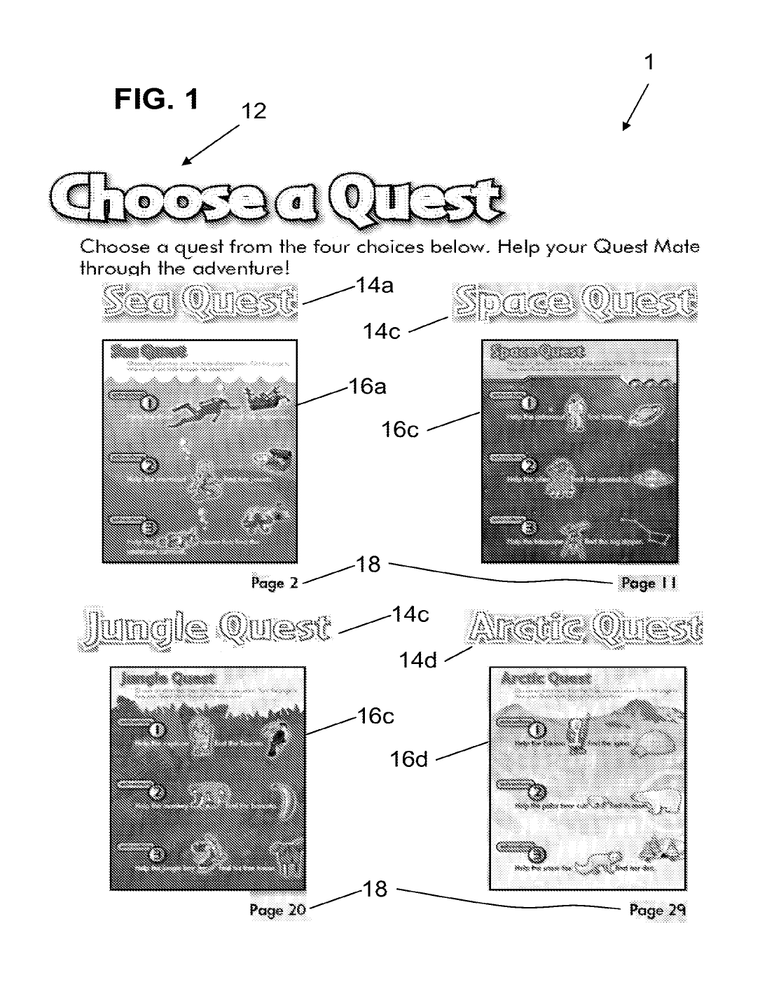

As shown in the attached FIGS. 1-10, a variety of sheets or pages, each having varying indicia, may be grouped and/or bound together to form a package. Each sheet may be made of a sheet-like material or body. The sheets/sheet-like body can be made of from any of a wide variety of materials but may be made of a cellulose-based or pulp-based paper such that the sheets are generally water absorbent and can be written upon by a wide variety of media (i.e. pens, pencils, markers, crayons, etc.) However, the sheets can be made of any of a relatively wide variety of materials, and may need not necessarily be a water-absorbent material. For example, the sheets could be a made of a write-on/wipe off (polymer) material that can be re-used, etc. Each sheet may be relatively thin, and may have a thickness of about 0.5 mm or less. The sheets may have a variety of shapes and/or sizes, but in one embodiment the sheets are generally rectangular, having dimensions of 8.5″×11″. Accordingly, sheets 1-10 take the form of sheets that are shown to scale, at least for one embodiment.

The sheets are designed such that the user can follow the instructions thereon and progress through the various sheets in order. Each sheet may have its own story, activities, and/or skills to be developed. Moreover, each sheet may reference skills or clues provided in the previous sheets.

The package may have one or more adventures, projects, or quests, to follow, with each quest being linked by a common theme. For example, as shown in FIG. 1, the package may have four quests. An index page 10 may be provided. This page may provide an invitation 12 to “Choose a Quest”, along with Quest Titles 14a, 14b, 14c, and 14d. Representative pictures 16a, 16b, 16c, and 16d may be provided which correspond to the four quests. Page numbers 18 may also be provided for each quest. For the embodiment shown here, the “Sea Quest” theme will be used as an example.

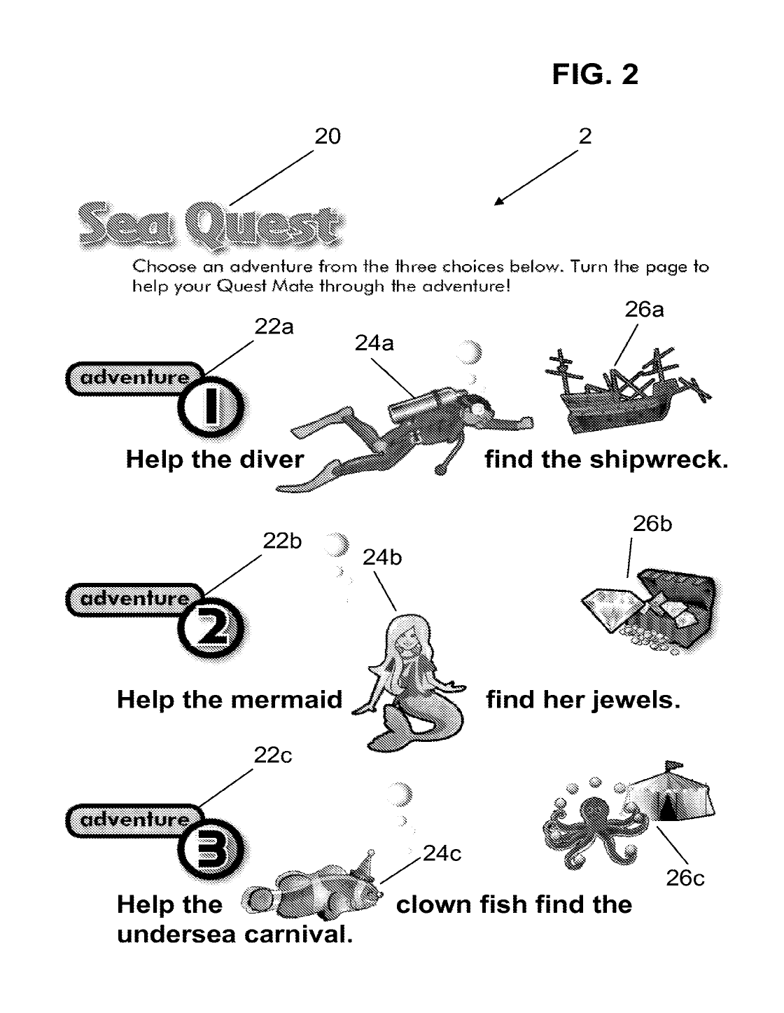

In the illustrated embodiment shown on sheet 2 (FIG. 2), the “theme” 20 is an underwater adventure or “Sea Quest,” and there are three discrete “adventures” within the theme: 1) helping a diver find a shipwreck; 2) helping a mermaid find jewels; and 3) helping a clownfish find a carnival. Sheet 2 includes three separate sets of indicia 22a, 22b, and 22c that outline the starting point 24a, 24b, and 24c and ending point 26a, 26b, and 26c of each “adventure” in the materials. For example, the indicia for adventure 1 indicates that that adventure involves helping a diver 24a (graphically illustrated) find the shipwreck 26a (also graphically illustrated). Other adventures may also be presented and may have other stated objectives, such as helping someone or something find, reach or discover an ultimate goal. The adventures can be pursued in any order. Once the adventure is chosen, the user is required to remember the drawing/representative on the initialization sheet (i.e., in the case of adventure 1, the user is required to remember the concept, or representation, of a diver). This aspect of visual memory is carried throughout the adventure/package.

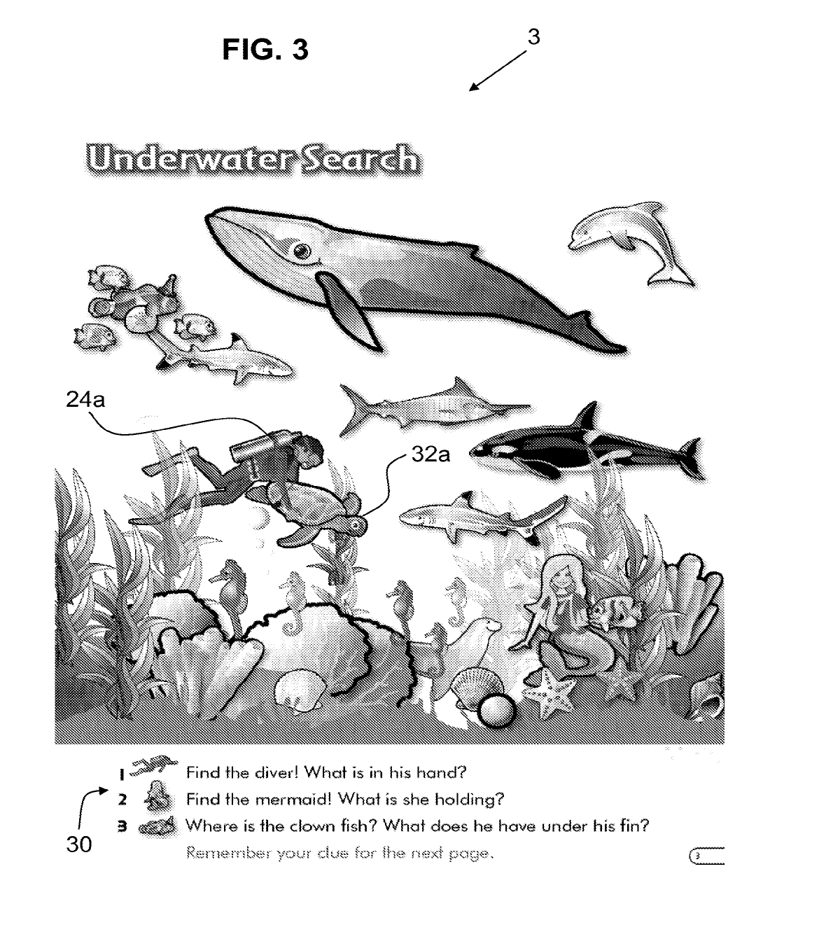

Next, on sheet 3, as shown in FIG. 3, the user is cued to identify the representation he or she selected on the initialization sheet (sheet 2). The instruction indicia 30 of sheet 3 then cues the user to identify some other indicia or visual component identified with the representation selected on the initialization sheet. For example, in following adventure 1, the user is requested to find the diver 24a and identify what the diver has in his hand. The instruction indicia 30 of sheet 3 has a number “1” next to the indicia, and also the representation of a diver (i.e. the “theme” of adventure 1) so the user knows which instruction indicia to follow.

The activities carried out on sheet 3 develop a user's visual memory and visual figure ground skills (i.e., the ability to find a particular item in a busy background). Once the user has identified the particular item (in this case, a sea turtle 32a), the user is cued to remember the item or clue (i.e., the sea turtle 32a), and then turns to the next sheet.

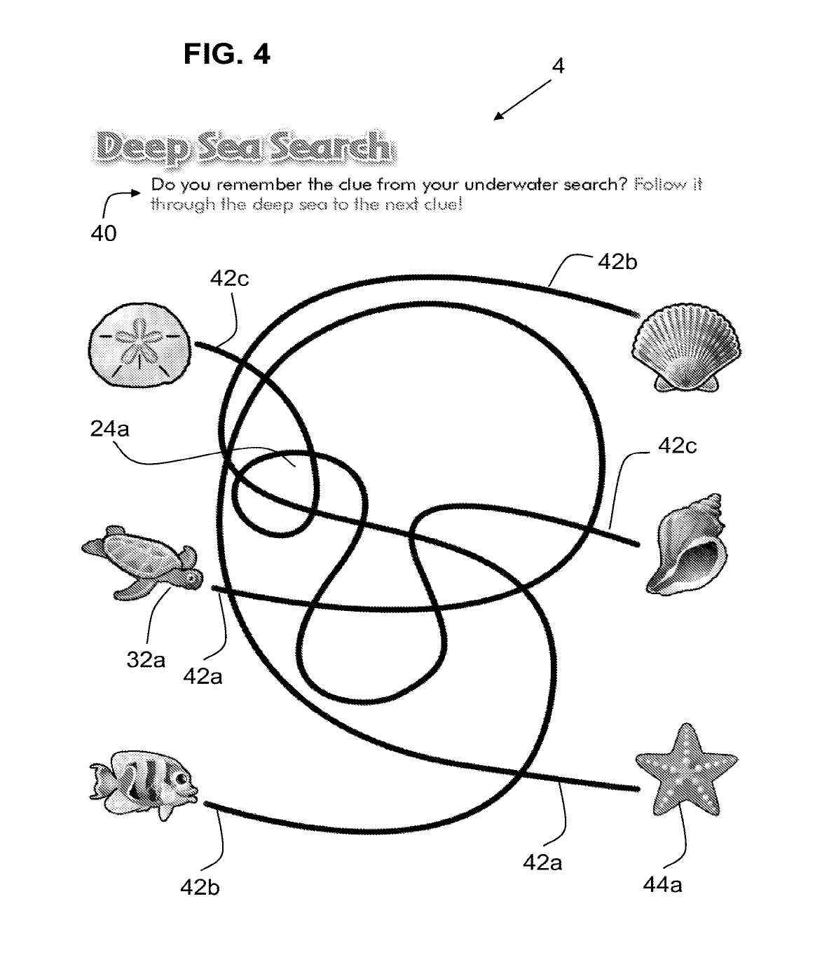

On sheet 4, as shown in FIG. 4, the user is cued to recall the item or clue identified on the previous sheet (in this example, the sea turtle 32a from sheet 3). The user is then cued 40 to begin at a visual representation 32a corresponding to the item or clue, and follow a line 42a through a set of convoluted or overlapping lines or paths 42b, 42c to identify the next item or clue 44a. The user may be cued to trace or follow the path 42a visually (which develops ocular motor skills), or to trace the path 42a with his or her finger (which develops visual motor control skills). Continuing with the example of adventure 1, it can be seen that beginning with the turtle 32a of sheet 4 provides next item/clue in the form of a starfish 44a.

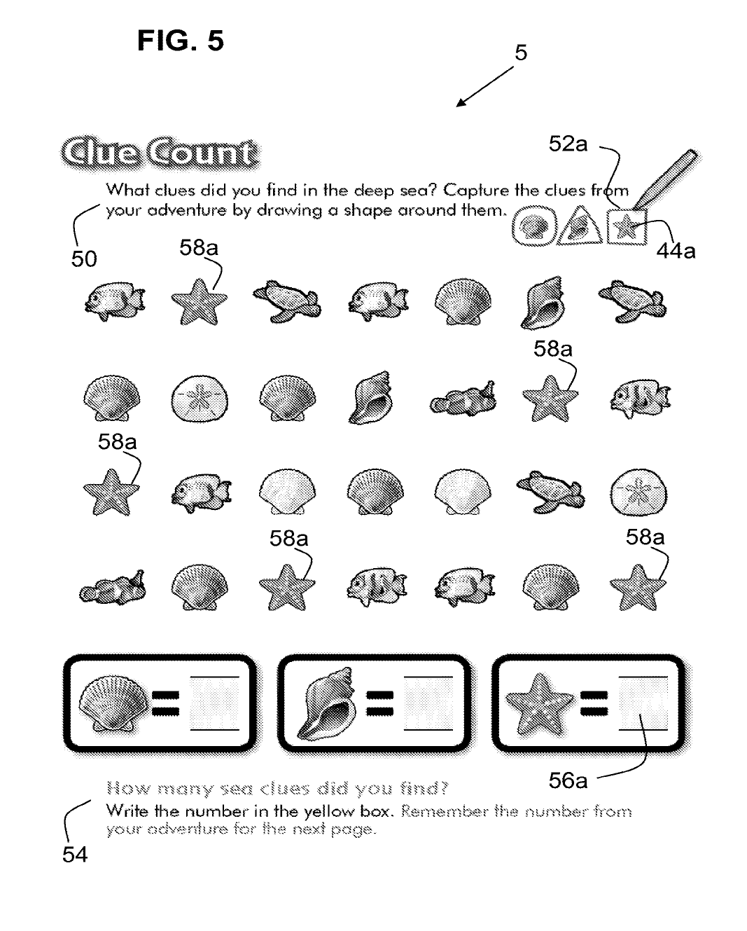

Next, on sheet 5, as shown in FIG. 5, the user is cued 50 to recall the item/clue 44a from sheet 4. The user is then cued to draw a particular shape 52a around the item/clue 44a. For example, sheet 5 presents a matrix of items/clues. The user is cued to draw a circle, triangle or square, respectively, around the appropriate item. At the bottom of sheet 5, the user is instructed 54 to count the number of clues identified on that sheet and write the number in the appropriate space 56a. Finally, the user is then cued to remember that number for continuing the adventure on the next page. For example, in the illustrative adventure, a user would draw a square around each of the five starfish 58a in the matrix, count the five squares/starfish, and write the number five in the appropriate space 56a. The activities on sheet 5 develop the user's visual tracking and visual motor integration skills, such as drawing age-appropriate pre-writing shapes and numbers.

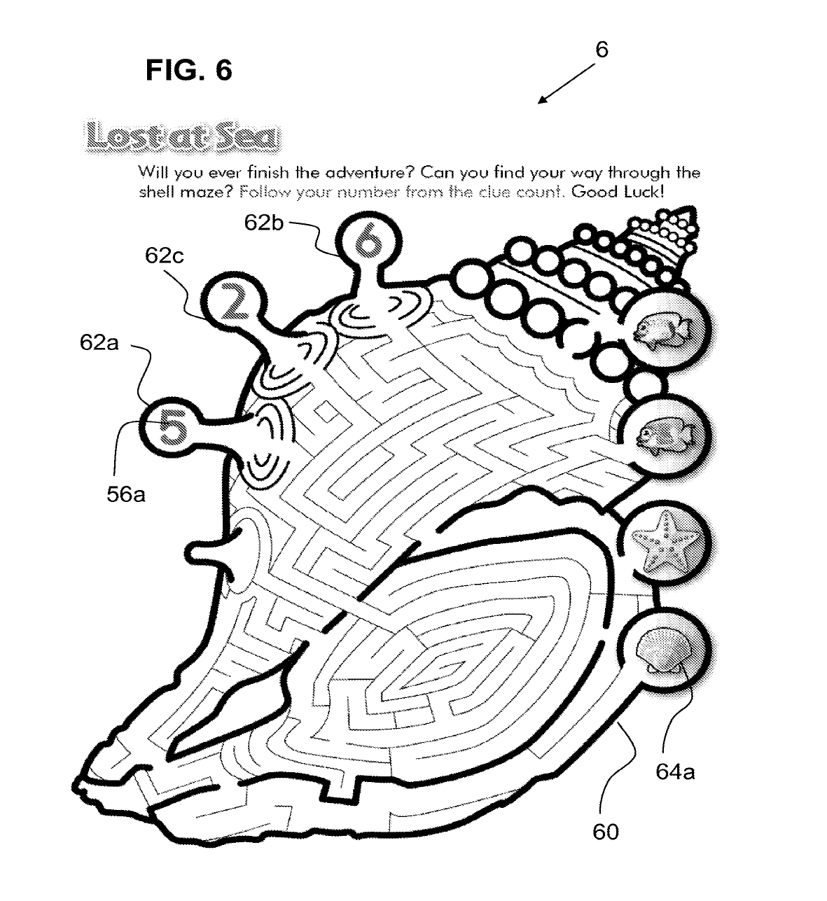

The user then progresses to the next sheet (sheet 6) as shown on FIG. 6 which presents a series of discrete mazes, one maze for each adventure. In the illustrated embodiment, the discrete mazes are integrated into a single shape 60 corresponding to the theme of the adventure/quest (i.e., a seashell shape 60 in the illustrated embodiment). Each discrete maze has a starting point 62a, 62b, and 62c marked with a numerical cue that is associated with the number written by the user at the bottom of the previous sheet. For example, in the illustrated example, the user is required to remember the number five (provided as a clue 56a in sheet 5). The user then begins at the maze 62a associated with the number five, and traces through the maze 60. Properly navigating through this maze will cause the user end up at the seashell 64a. The activities on sheet 6 develop the user's visual tracking, visual planning, visual motor control and visual figure ground skills.

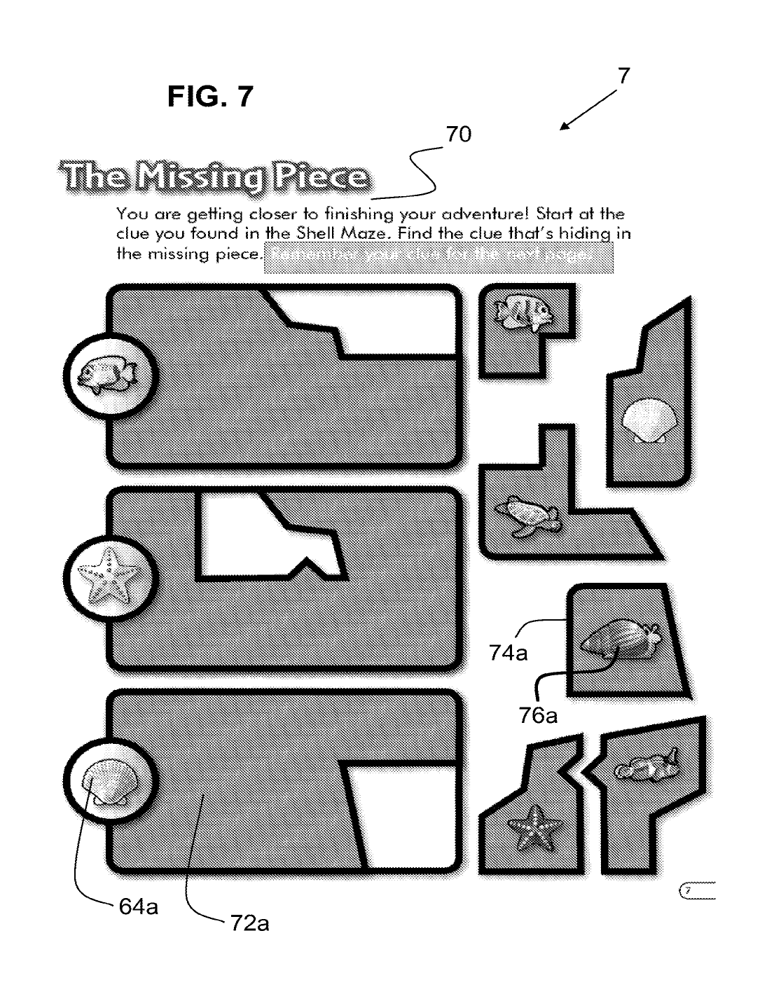

The user then progresses to the next page or sheet as shown in FIG. 7 (sheet 7 in the illustrated embodiment). Sheet 7 prompts 70 the user to first to identify the indicia from the previous page (in the illustrated example, the seashell 64a). The indicia then cues the user to identify the incomplete shape 72a corresponding to the indicia identified on sheet 6. The user is then cued to find the piece 74a that completes the incomplete shape, and identify the indicia 76a associated with the piece. The piece may need to be visually rotated from its illustrated configuration in order to mate with the incomplete shape, which develops the user's visual form constancy and visual closure skills.

For example, in the illustrated embodiment following adventure 1, the user is cued to identify the piece that completes the bottom rectangle shape 72a associated with the shell 64a of sheet 7. Proper completion of this challenge will lead the user to identify the generally rectangular piece 74a associated with a snail 76a. The activities on sheet 7 thus develop the user's visual form constancy and visual closure skills.

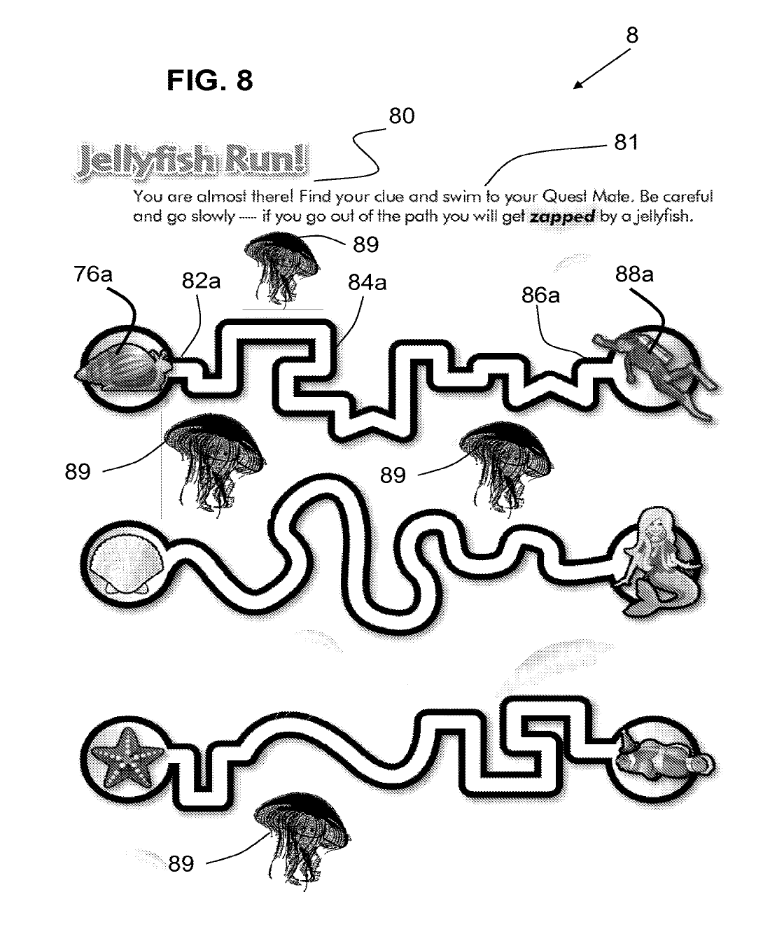

Turning to the next page, sheet 8 as shown on FIG. 8, the user is first cued 80 to recall the item/clue 76a from sheet 7 as a starting point. The user is instructed to trace through an irregular path 84a from the starting point 82a to an ending point 86a (identifying further indicia 88a) while staying within the lines outlining the path. In the illustrated case, the indicia at the ending point of the path is the same indicia identified as the starting indicia on the initialization sheet of sheet 2 (i.e., a diver in adventure 1 of the illustrated embodiment). The user is encouraged 81 to stay within the printed path 84a in the illustrated embodiment by suggesting that the user will get “zapped” by a jellyfish 89 if the user strays outside the lines. The activities on sheet 8 develop visual motor control skills.

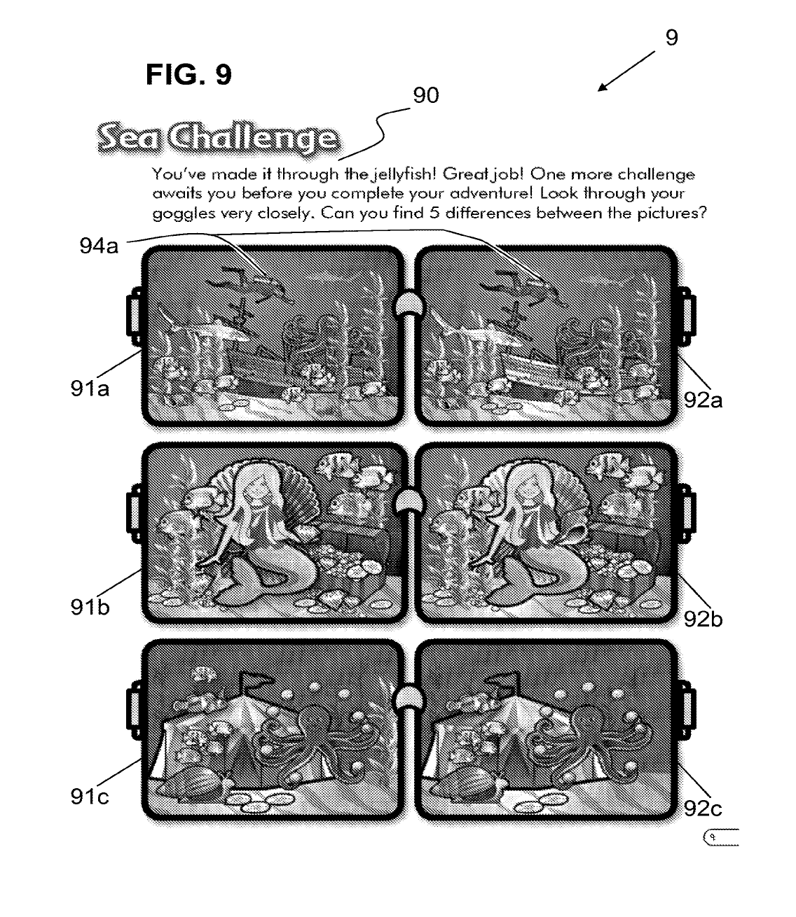

On the next page (sheet 9) as shown on FIG. 9, two pictures 91a, 92a are presented that are similar but that have a predetermined number of differences. The user is cued 90 to find the predetermined number of differences (i.e., five differences in the illustrated embodiment). The initial indicia (i.e., a visual representation of the diver 94a) may be present in the associated picture 91a, 92a on sheet 9 to aid the user in determining which set of pictures 91a, 92a, or 91b, 92b, or 91c, 92c is to be studied. The activities on sheet 9 thereby develop visual discrimination skills.

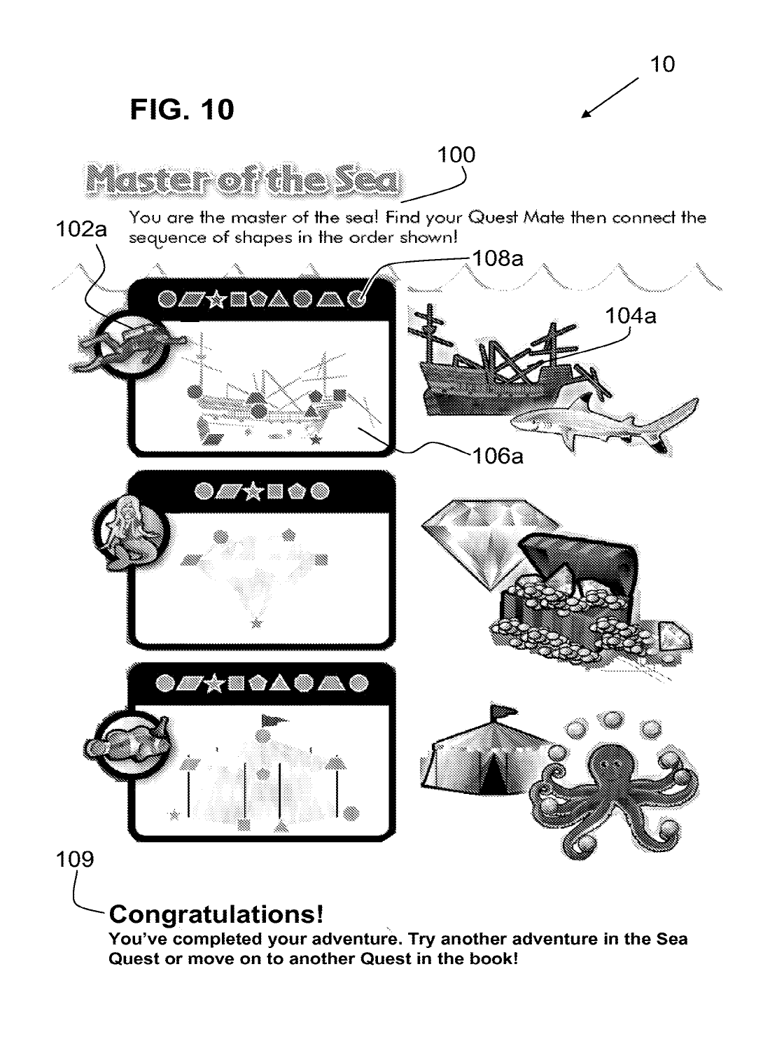

Once the differences on sheet 9 are correctly identified, the user then turns to the next page (sheet 10 in the illustrated embodiment, as shown on FIG. 10). In this case, the initial indicia (i.e., a visual representation of the diver 102a) is repeated, and a pictorial representation of the end indicia 104a associated with that adventure (i.e., a sunken ship) is also presented. In addition, a “connect the dots”, or incomplete, illustration 106a of the end indicia is also presented. The user is then instructed 100 to complete the incomplete version of the end indicia in a “connect-the-dots” manner as guided by the sequence of shapes 108a presented adjacent to the picture 106a to be completed.

For example, in the illustrated embodiment, a series of geometric shapes 108a is presented in a linear manner above the “complete the dots” picture 106a to provide a guide. The “dots” of the incomplete version of the end indica take the form of the geometric shapes. The user is thereby cued to connect the dots in the incomplete version of the end indicia, in the same order that the dots are arranged in the guide. Once the dots are connected in the proper manner, a complete shape corresponding to the end indicia is presented.

The connect-the-dots challenge in sheet 10 helps to develop a user's shape and pattern recognition, visual sequential memory, ocular motor skills, and visual closure skills. However, the connect-the-dots can take any of a wide variety of forms besides the “connect-the-shapes,” challenge shown in sheet 10 such as, for example, standard numbered connect-the-dots, color coded connect-the-dots, combination of colors, and/or shapes, and/or numbers, etc. U.S. patent application Ser. No. 11/847,845, entitled Sequence Dot Connect Sheets, filed on Aug. 30, 2007, the entire contents of which are hereby incorporated by reference, discloses various manners in which the connect-the-dot portions of sheet 10 can be configured.

Once the user has completed the outline or form of the end indicia in sheet 10, the user is congratulated 109 at the bottom of the page and cued that the adventure has been completed. If desired, the user can then return to the initialization sheet (sheet 2) and carry out another adventure or quest (i.e., adventures 2 or 3 in the illustrated embodiment). Accordingly, the package/sheets of the present invention may include multiple, parallel uses or projects while providing a number of discreet and unique learning experiences for the user.

Moreover, the package may develop all seven visual perceptual skills (visual discrimination, visual memory, visual spatial relationships, visual form constancy, visual sequential memory, visual figure ground, and visual closure), as well as the three perceptual motor skills (visual motor integration, visual motor control and ocular motor skills). Each quest and/or adventure may develop all seven visual perceptual skills and the three perceptual motor skills. Alternately, each quest and/or adventure may develop only some of the seven visual perceptual skills and the three perceptual motor skills, in which the other quests and/or adventure is the same package/booklet/bound component may develop the missing seven visual perceptual skills and the three perceptual motor skills.

The system of the present invention provides an interesting and challenging task set that motivates the user to use increasing skills and endurance to complete the task at hand. For example, it may take a typical user about fifteen to twenty minutes to complete all (three) adventures in a single quest/system, thereby pushing the outer limits of visual endurance for children of the target age group (i.e., between kindergarten and second grade). Moreover, each page or discreet task is dependant upon the one before, thereby building upon previous skills and requiring the user to remember a clue or cue from the previous page to the next succeeding page.

Having described the invention in detail and by reference to the various embodiments, it should be understood that modifications and variations thereof are possible without departing from the scope of the invention.

What is claimed is:

1. A method for developing a user's perceptual motor skills comprising:
providing a plurality of sheets that define a project to be completed by a user, wherein at least some of the sheets include indicia providing a skill development activity, wherein the indicia for at least one skill development activity on at least one of the plurality of sheets contains a clue to be identified by the user, and wherein the user's identification of the clue is necessary for the user to complete the skill development activity represented by the indicia of another of the plurality of sheets;
cuing the user, via at least one of the plurality of sheets, to complete the skill development activity on the sheet containing the clue to thereby identify the clue; and
cuing the user, via at least one of the plurality of sheets, to use the identified clue to complete the skill development activity on another of the plurality of sheets, wherein the skill development activities are configured to collectively develop the user's visual discrimination skills, visual memory skills, visual spatial relationship skills, visual form constancy skills, visual sequential memory skills, visual figure ground skills, and visual closure skills.

2. The method of claim 1 further comprising cuing the user, via at least one of the plurality of sheets, to complete the skill development activity on the another of the plurality of sheets and thereby identify a second clue therein, and cuing the user, via at least one of the plurality of sheets, to use the identified second clue to complete the skill development activity on a third of the plurality of sheets.

3. The method of claim 1 wherein the plurality of sheets define a plurality of projects to be completed by the user, wherein the method further comprises cuing the user, via at least one of the plurality of sheets, to select one of the plurality of projects.

4. The method of claim 3 wherein each project includes a theme and goal that is carried throughout the indicia on the plurality of sheets.

5. A method for developing a user's perceptual motor skills comprising:
providing a first sheet having first activity indicia defining a first skill development activity and a clue, the clue comprising a pictorial graphic that is embedded or incorporated in the first activity indicia;
providing a second sheet having second activity indicia defining a second skill development activity, the second activity indicia including a plurality of starting points for the second skill development activity, wherein each starting point has an associated ending point, and wherein exactly one of the plurality of starting points includes indicia that corresponds to the clue of the first sheet;
cuing a user to complete the first skill development activity; and
cuing the user to complete the second skill development activity, wherein the cuing step includes referencing the clue.

6. The method of claim 5, further comprising cuing the user to select one of at least two discrete projects, wherein the first activity indicia of said first sheet and the second activity indicia of said second sheet each present project-related indicia and clues for each of the at least two discrete projects;
wherein the clue of the first sheet is a first clue, and wherein the first sheet further includes a second clue, the second clue comprising a pictorial graphic that is embedded or incorporated in the first activity indicia; and
wherein exactly one of the plurality of starting points of the second sheet includes a reproduction of the second clue of the first sheet.

7. The method of claim 6, wherein each discrete project has a theme and goal, and wherein the projected-related indicia for each project corresponds with the respective project's theme and goal.

8. The method of claim 5, wherein the first skill development activity is a task selected from the group consisting of locating a hidden object, tracing a path, drawing a shape, writing an alphanumeric character, visually scanning and tracking in a left-to-right and top-to-bottom manner, recognizing two shapes to be the same, visually discriminating between two similar pictures, recognizing an object from a partially-completed picture of the object, remembering a sequence of items and movements, remembering a picture across a plurality of pages, recognizing an object facing a different direction from another like object, controlling a writing implement along a path involving angles and/or curves, and counting.

9. The method of claim 8, wherein the second skill development activity is a task selected from the group consisting of locating a hidden object, tracing a path, drawing a shape, writing an alphanumeric character, visually scanning and tracking in a left-to-right and top-to-bottom manner, recognizing two shapes to be the same, visually discriminating between two similar pictures, recognizing an object from a partially-completed picture of the object, remembering a sequence of items and movements, remembering a picture across a plurality of pages, recognizing an object facing a different direction from another like object, controlling a writing implement along a path involving angles and/or curves, and counting, wherein the second activity indicia includes content corresponding with the first instruction indicia, and wherein the task of the first skill development activity is different from the task of the second skill development activity.

10. The method of claim 5, further comprising providing a third sheet having third activity indicia defining a third skill development activity, the third activity indicia including a plurality of supplemental starting points for the third skill development activity, each supplemental starting point having an associated supplemental ending point, wherein the second activity indicia of the second sheet has a supplemental clue that is embedded or incorporated therein, the supplemental clue comprising a pictorial graphic, and wherein exactly one of the plurality of supplemental starting points of the third activity indicia of the third sheet includes a reproduction of the supplemental clue of the second activity indicia of the second sheet; and
cuing the user to complete the third skill development activity, wherein the cuing step to complete the third skill development activity includes referencing the supplemental clue.

11. The method of claim 5, wherein the providing the first sheet step occurs before the providing the second sheet step.

12. The method of claim 5, further comprising providing instruction indicia to implement the cuing steps.

13. A method for developing a user's perceptual motor skills comprising:
providing a plurality of sheets;
providing, on each of the plurality of sheets, a skill development activity to be completed by a user, wherein collectively, the skill development activities of the plurality of sheets require the user to employ or develop each of the user's visual discrimination skills, visual memory skills, visual spatial relationship skills, visual form constancy skills, visual sequential memory skills, visual figure ground skills, and visual closure skills;
providing pictorial indicia on each of the plurality of sheets, the pictorial indicia defining a theme that provides a thematic link between the plurality of sheets;
coupling the plurality of sheets together in a predetermined order; and
cuing the user to complete the skill development activities of the plurality of sheets in the predetermined order.

14. The method of claim 13, further comprising providing supplemental pictorial indicia on each of the plurality of sheets, the supplemental pictorial indicia defining a supplemental theme that provides a supplemental thematic link between the plurality of sheets.

15. The method of claim 14, further comprising cuing the user to select either the theme or the supplemental theme, wherein the selection cuing step occurs before the completion cuing step, wherein the user's selection of the theme or the supplemental theme impacts an outcome of each of the skill development activities of the plurality of sheets.

16. The method of claim 13, wherein the skill development activity of each of the plurality of sheets is a task selected from the group consisting of locating a hidden object, tracing a path, drawing a shape, writing an alphanumeric character, visually scanning and tracking in a left-to-right and top-to-bottom manner, recognizing two shapes to be the same, visually discriminating between two similar pictures, recognizing an object from a partially-completed picture of the object, remembering a sequence of items and movements, remembering a picture across a plurality of pages, recognizing an object facing a different direction from another like object, controlling a writing implement along a path involving angles and/or curves, and counting.

17. The method of claim 13, further comprising providing an initialization sheet sequentially before the plurality of sheets, and providing starting indicia and ending indicia on the initialization sheet;
providing the starting indicia on a first of the plurality of sheets; and
providing the ending indicia on a last of the plurality of sheets.

18. The method of claim 17, wherein the ending indicia is provided only on the initialization sheet and the last of the plurality of sheets.

19. The method of claim 13, wherein the skill development activities include cuing the user to find a hidden object, trace a path, draw a shape, write and alphanumeric character, and count.
